(19) United States
(12) Patent Application Publication
(10) Pub. No.: US 2014/0189484 A1
(43) Pub. Date: Jul. 3, 2014

(54) USER ABILITY-BASED ADAPTIVE SELECTING AND PRESENTING VERSIONS OF A DIGITAL CONTENT ITEM

(71) Applicant: Daniel James Fountenberry, New York, NY (US)

(72) Inventor: Daniel James Fountenberry, New York, NY (US)

(73) Assignee: Daniel James Fountenberry, New York, NY (US)

(21) Appl. No.: 14/133,636

(22) Filed: Dec. 18, 2013

Related U.S. Application Data
(60) Provisional application No. 61/738,993, filed on Dec. 18, 2012.

(51) Int. Cl. G06F 17/22

(52) U.S. Cl. CPC G06F 17/2288
USPC 715/229

(57) ABSTRACT

A content publishing system retrieves user identification information and interaction information associated with a user of the content publishing system. The content publishing system provides a selected content item to the user and calculates a user score representing a reader's reading ability. The score is calculated based on the retrieved user identification information and interaction information. Using the calculated score, content publishing system generates instructions for dynamically selecting a particular version or representation of a selected content item based on the calculated user score associated with the viewing user. The generated instructions are retrieved by a viewing application residing on a client device and used to select the appropriate version of the previously selected content item to present to the user.

### CROSS REFERENCE TO RELATED APPLICATIONS

This application claims the benefit of U.S. Provisional Application No. 61/738,993, filed Dec. 18, 2012, which is incorporated by reference in its entirety.

### BACKGROUND

1. Field of Art

The disclosure generally relates personalizing digital content based on attributes of a reader of the digital content.

2. Description of the Related Art

Electronic books and other digital content offer a wide variety of content to readers using electronic reading devices. Digital content providers, such as publishers, often develop content suited for a particular age or educational level. The determination of whether the content is suited for a particular reader is often based on historical or generalized criteria. The reading ability of an individual, however, often varies widely within an age group. Readers falling short of grade or age level reading standards often struggle, resulting in an undesirable reading experience.

### SUMMARY

A content publishing system adaptively selects one or more representations of a digital content item for presentation to a user based on information or signals that indicate the user's reading ability. The content publishing system comprises a plurality of digital content items available for selection by a viewing user using a mobile device or application software, such as a web browser or electronic reader application, residing on a computing device. A digital content items included in the content publishing system is organized as a multi-component file. The components include content (e.g., core text), assessment information, and user assist information. Each component includes one or more representations, each representation adapted for a different literacy and fluency level of a reader.

In one embodiment, a viewing user selects such a digital content item from the content publishing system. Responsive to the selection, the content publishing system selects one or more representations of the selected digital content item to send to a viewing device associated with the requesting viewing user. In one implementation, the content publishing system determines which representations of each component of the selected digital content item to send based on an expected user score. In another implementation, the content publishing system determines which representation of each component of the selected digital content item for display to the viewing user based at least in part on a calculated user score. The content publishing system calculates or updates a user score based at least in part on user interaction information. User interaction information describes interactions of the viewing user with digital content items included in the content publishing system, interactions with content items external to the content publishing system, or interactions of other users of the content publishing system that may be used to infer interaction information about a particular viewing user.

To calculate or update a user score for the viewing user, the content publishing system applies a set of rules to one or more attributes of the interaction information for a viewing user. Based at least in part of the calculated or updated user score, the content publishing system sends instructions to the viewing device associated with the viewing user for selecting the appropriate representation of the digital content item to display to the viewing user. In one implementation, the viewing device includes code that when executed by a processing device included in the viewing device sends instructions to select from multiple representations of one or more of content, user assist information, or user assessment information based on one or a combination of calculated user score or interaction information obtained by the viewing device. By employing such a system, the content publishing system provides a user-based adaptive reading experience even while the viewing device used by the viewing user to interact with a selected content item is no longer in communication with the content publishing system (i.e., off-line).

### BRIEF DESCRIPTION OF THE DRAWINGS

FIG. 1 is a block diagram of a system environment in which a content publishing system operates, in accordance with an embodiment.

FIG. 2 is a flowchart of a process for selecting a representation of a digital content item, in accordance with an embodiment.

FIG. 3 is a flowchart of another process for selecting a representation of a digital content item, in accordance with an embodiment.

The figures depict various embodiments of the disclosure for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A content publishing system retrieves user identification information and interaction information associated with a viewing user of the content publishing system. The content publishing system provides a selected content item to a viewing user and calculates a user score representing a reader's reading ability (e.g. level of literacy and fluency) based at least in part on the retrieved user identification information and interaction information. Using the calculated score, content publishing system generates instructions for dynamically selecting a particular version or representation of a selected content item based on the calculated user score associated with the viewing user. The generated instructions are retrieved by a viewing application, such as an electronic reader application or web browser executing on a computing device (such as a mobile communication device, a tablet computer, or any other suitable computing system) and used to select the appropriate version of the previously selected content item to present to the user. For example, based on interaction information indicating that the viewing user progressed through a portion of a selected content item quickly or made notes or annotations to the selected content item during a viewing session, the content publishing system increases the viewing user's user score. Based on the increased user score, the content publishing system generates instructions for selecting an alternative content version for presentation to the viewing user. During the same or during a different viewing session, the generated instructions are retrieved by a viewing application and used to select an alternative version of the previously selected content that is adapted for a user with a higher reading ability as compared to the previously viewed content version. The generated instructions also operate in conjunction with the selected content item on the computing device used by the viewing user to interact with the selected content item to log interaction information describing one or more interactions by the viewing user with the selected digital content item.

Such a system allows the selected digital content item to exchange information with the content publishing system to provide an interactive reading experience across a range of devices, including personal computers, smart phones, tablet computers, and smart boards, using a web browser or electronic reader (eReader) application. In turn, a viewing user can interact with multiple alternative versions of a content item in an offline mode (e.g., not connected to the content publishing system). The client device can also retrieve logic (e.g., rules about how the content that has been downloaded to the client device should adapt, given the users interactions with the content) from the content publishing system, which enables the experience to be adaptive even in offline mode. The content publishing system can insert or inject new information (core text, assessment, assist information) into the content items that can be viewed later in either online or offline mode. The content publishing system also selectively determines which set of alternative versions of a selected content item to provide to a viewing user based on the calculated user score. For example, the content publishing system may use historical or global interaction information to a set of alternative version, where each version included in the set varies by a specified attribute (e.g., specified level of reading complexity or reader score). Such as system utilizes minimal computing resources of the viewing device and reduces the data bandwidth consumed to exchange information between the computing device and the content publishing system.

A digital content item is organized into a number of components or sections, each including one or more alternative representations or version of the information included in the section. In one implementation, sections include core text and metadata. Metadata includes user reading assessment information, such as questions about the core text used to assess a user's reading ability of a selected content item. In one implementation, the questions are presented as text, symbols, characters, tactile writing system, or other humanly perceivable representation of text in varying formats, including multiple choice, doze, and open-ended questions. In such an implementation, the user reading assessment information may be positioned to appear directly in the core text proximate to a relevant portion of the core text, alongside the core text, or hidden from view and revealed when a viewing user interacts with a specified portion a display region of the computing device used to interact with the selected content item (i.e., a viewing device). In another implementation, the questions are presented audibly and audible responses are captured by an audio recording device accessible by the viewing device.

Metadata also includes user assist information, including vocabulary support, the option to reformat the core text based on user preference, and the option to manually choose an alternative version of the core text of a selected content item. User assist information also includes visual (e.g., highlights) or audible modification of portions of the core text to increase the viewing user's comprehension of the core text. For example, the user assist information includes providing the viewing user an alternative version of the core text in which the vocabulary and grammar as well as the structure of the prose is greatly simplified, inserting in or revealing conditional text at a specific point in a selected content item to help a viewing user better comprehend the text that they are reading or to answer a specific question about the text. As described herein, text refers to default text of a digital text and conditional text refers to supplemental text written about the content item to accompany the item. In another example, the user assist information includes revealing text, audiovisual media, and links to other media, any of which may be intended to help the viewing user read and comprehend the text of the content item that they are reading, or directing the user back to a specific point in a selected content item to point out to the viewing user text that was needed to answer a questions that they answered incorrectly. More generally, the user assist information assists the viewing user to decode words, phrases, or portions of core text, and comprehend portions of the core text that would be otherwise beyond the viewing user's literacy, comprehension, or fluency.

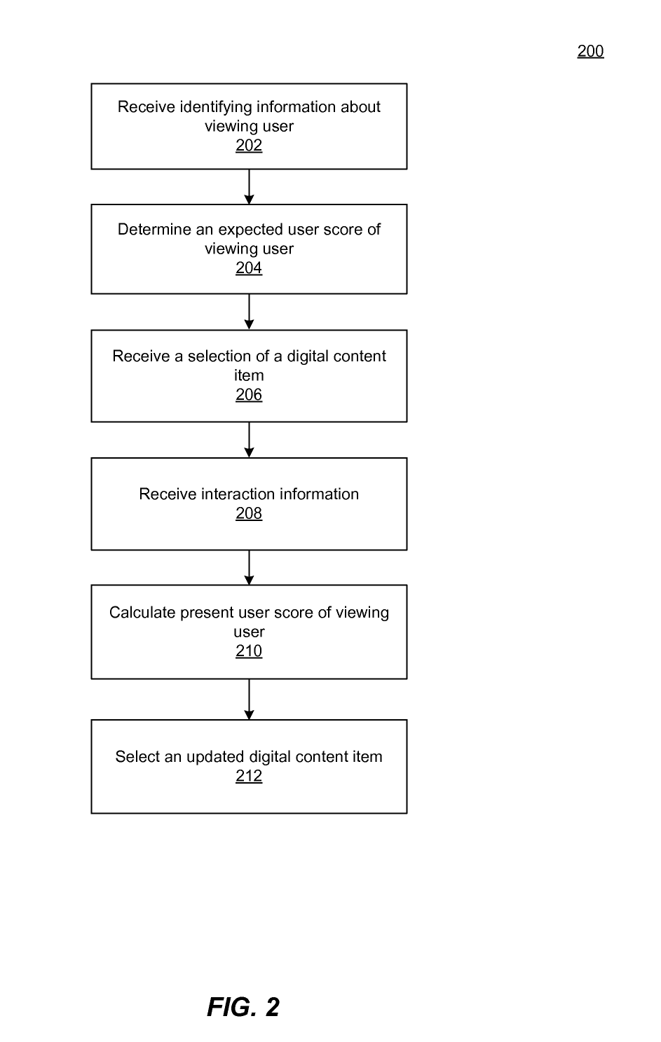

Generally, each alternative version of a section of a content item is assigned a user score or range of user scores. The user score, as described in reference to FIG. 2, provides an indication of a particular user's reading ability. Accordingly, because the alternative version are tagged with a user score or range of user scores the content publishing system may generate instructions that when executed by an application on a viewing device, dynamically select from a set of alternative versions of core text, user assessment, and user assist information based on a user score calculated for a particular viewing user. Where the calculated user score takes into account factors that indicate a viewing user's present reading ability.

Alternative versions of the core text may vary in the level or complexity of vocabulary, grammar, sentence structure, while keeping the underlying meaning of and information conveyed by the core text substantially similar across all versions of the core text associated with a particular digital content item. Alternative versions of user assist features may include providing the user specific media, specific information, or specific advice at specific times to increase their likelihood of comprehending the material that they are viewing. For example, the content publishing system 112 may prompt a viewing user to read more slowly, or indicate to a viewing user that a passage that they just read is the main idea of the passage, so that the viewing user understands the passage better. The content publishing system 112 determines when is the best time to provide user assist information to increase their comprehension of the content item they are viewing based at least in part on computed user score. The content publishing system 112 may also provide the viewing user with a plurality of assessment versions. As the content publishing system gathers information and updates the user score it makes decisions about what assessment to provide a user. The primary purpose of assessment is to determine the most optimal version of the content item for a viewing user. Thus, the assessment will become more difficult or less difficult as needed to pinpoint the optimal level of difficulty for a particular user.

The assessment is also used by the content publishing system 112 to identify the viewing user's skills and knowledge or gaps in their skills and knowledge. The content publishing system 112 provides a user a plurality of assessment versions and measures response to those assessments, so that the content publishing system 112 creates an inventory of the viewing user's skills and abilities. Two users could be viewing the same content item (or modified versions of a content item) and see completely different assessment. The content publishing system 112 may retrieve new assessment and add those assessments to a content item that a viewing user is viewing in offline mode. The content item will also download the answers to those questions and logic to act on in response to those answers. Thus, viewing user can have an adaptive experience even in an offline mode.

For purposes of illustration, a digital content items included the content publishing system is referred to herein as “content item”, which may include textual articles, books, videos, and any other types of content capable of display within the context of an electronic reader application or web browser.

### System Architecture

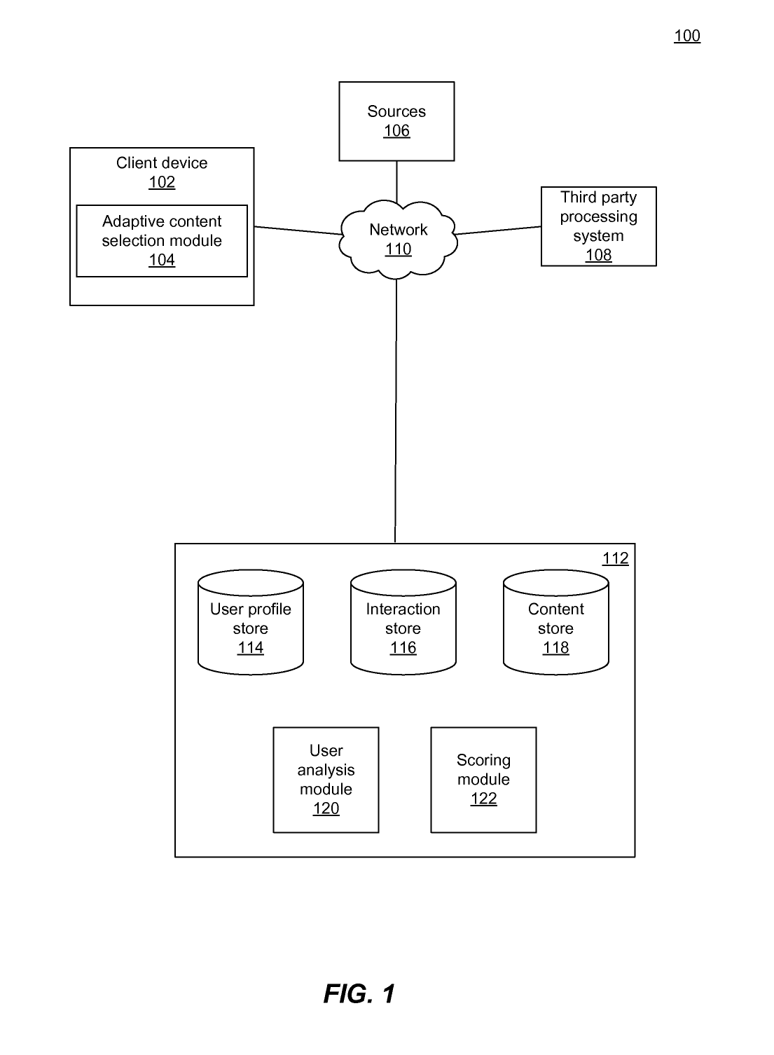

FIG. 1 is a block diagram of a system environment 100 in which a content publishing 102 system operates. The system environment 100 shown by FIG. 1 comprises one or more client devices 102, one or more sources 106, third party processing system network 110, and the content publishing system 112. In alternative configurations, different and/or additional components may be included in the system environment 100. For example, in an alternative configuration, the system 100 includes supplemental user information providers, such as schools or test administration organizations that may provide information about a user's academic or examination performance, information about the academic or examination performance of a group of people. The group may be specified by one or a combination of grade level, geography, socioeconomic criteria, nationality, ethnicity, or other suitable criteria that may influence a user's reading ability.

A source 106 includes a computing system capable of providing various types of content to the content publishing system 112 for display on a client device 102. Examples of content provided by a source 106 include text, images, video, audio or other suitable data. The content provided by a source 106 may be received from a publisher (e.g., books, videos, or educational material) and distributed by the source 106, or a source 106 may be a publisher of content it generates. For example, a publisher refers to any person or entity that provides multimedia to the content publishing system 112, which users can read, watch, play, or interact with, and to which administrative users can add additional information (e.g., meta media).

An administrative user is a person who has the right to view and or modify data on a specific user. In general, an administrative user will be a parent, guardian, teacher, instructor, educational professional, or some person who is responsible for the instruction or care of another user. The content publishing system 112 provides a user interface, such as a dashboard to enable an administrative user to access profiles of users for which they are approved to do so. An administrative user may manually set the reading score of any user, for which they have administrative authority. An administrative user may also override the reading score assigned by the content publishing system 112 and may modify how the content publishing system 112 calculates reading scores for users that full under their administrative authority. An administrative user may author and attach meta media to a published work. The meta media, includes text, test questions, or related multimedia. If the administrative user authors questions, the administrative user may then also define a correct answer, and also define how answering the question correctly and incorrectly impacts a user's reading score. An administrative users may define which users (student or administrative) may view meta media, which that administrator created. An administrative users access the meta media of other administrative users and permission those users under their control to view and engage with meta media from other administrators. An administrative user may make their meta media public and freely available or make it available to specific a user or specific administrator. An administrative user may also charge other administrators and users to access their meta media. Thus, the content publishing system 112 platform creates a market where administrators can buy, sell, and rent or freely give away their meta media. The content publishing system platform enables administrative users to create meta media, store meta media, provide meta media to users based on rules provided by the administrator, incorporate interactions and engagement with meta media into the calculated user reading score, and provide a marketplace to distribute the meta media with multiple business models.

Returning to publishers, a publisher may upload documents in a wide variety of formats (.txt, .doc, PDF (Portable Document Format), CSS (Cascading Style Sheets), HTML (Hyper Text Markup Language, etc.) and convert those into adaptive, dynamic, multilevel books using the content publishing system 112. A publisher may define sections of a content item, such as the core text as the primary text (the default text provided to the reader), and alternative versions of the core text as secondary text, which may be substituted for the primary text when requested by a user or administrator on a users behalf, or substituted for the primary text after the software program on the content publishing system 112 determines that an alternative version of the core text is the best text for the reader, based on their reading score.

In one implementation, a publisher creates user assessment information (e.g., test questions), define the correct responses for those questions, and also determine how the user's reading experience should adapt or not adapt, based on the user's ability to answer questions about the text correctly or incorrectly. A publisher also sets rules defining the conditions that determine which version of a text, primary text of secondary text (alternative versions of core text), is present to a specific user, based on the users reading score or other unique factors. A publisher may also set an expected user score for content items provided by the publisher. For example, publishers may set an expected user score based on one or a combination of age, education level, user attributes, specifying how a user should interact with a content item. Expected interactions may include, the pace at which a user is expected to read a given page of text, what questions a user should be able to answer correctly about the text, the minimum level of reading ability that a user should be capable of demonstrating when reading a text aloud, and the maximum level of support a user should need to complete a text. The publisher may provide the expected interaction information to the content publishing system 112 for use in calculating or update a present user score for a viewing user and selecting the appropriate version of a selected content item to present to viewing user. When a user interacts with a publisher's content item, the content publishing system 112 compares those interactions to the expected interactions defined by the respective publisher or administrative user. The content publishing system 112 calculates a user reader using their interactions with the content items on the content publishing system 112 relative to the publishers and administrators expectations.

The sources 106 communicate with the client device 102 and the content publishing system 112 via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

The client device 102 is one or more computing devices capable of receiving user input as well as transmitting and/or receiving data via the network 120. In one embodiment, the client device 102 is a conventional computer system, such as a desktop or a laptop computer. Alternatively, the client device 130 may be a device having computer functionality, such as a personal digital assistant (PDA), a mobile telephone, a smart phone, a tablet computer, smart board, or another suitable device.

In one embodiment, the client device 102 executes an application allowing a user of the client device 102 to interact with the content publishing system 112. For example, an application executing on the client device 102 communicates instructions to select from multiple representations of one or more of content, user assist information, or user assessment information based on one or a combination of calculated user score or interaction information obtained by the viewing device. As another example, the client device 102 executes a browser that presents the selected content item to a user of the client device 102. In another embodiment, the client device 102 interacts with the content publishing system through an application programming interface (API) running on a native operating system of the client device 102, such as IOS® or ANDROID™ . While FIG. 1 shows a single client device 102, in various embodiments, any number of client devices 102 may communicate with the content publishing system 112.

The client device 102 includes a display device to presents content items to a user of the client device 102. Examples of the display device include a liquid crystal display (LCD), an active matrix liquid crystal display (AMLCD), an organic light emitting diode (OLED) display, or any other suitable device. Different client devices 102 may have display devices with different characteristics. For example, different client devices 102 have display devices with different display areas, different resolutions, or differences in other characteristics.

The client device 102 includes one or more input devices to receive input from the user. Different input devices may be included in the client device 102. For example, the client device 102 includes a touch-sensitive display for receiving input data, commands, or information from a user. In other embodiments, the client device 102 may include a keyboard, a trackpad, a mouse, or any other device capable of receiving input from a user. In another example, the input device is configured to receive information from a user of the client device through a touchless interface. Examples of a touchless interface include sensors, such as an image capture device, to receive gestures from a client device user without the user physically contacting the display device or the client device 102. Additionally, in some embodiments, the client device 130 may one or more sensors capable of detecting user biometric information (e.g., eye tracking) Inputs received via the input device may be processed by the adaptive content selection module 104 to interpret interaction information, respond to instructions from the content publishing system 112 to select from multiple representations of one or more section of a selected content item, or select from multiple representations of one or more section of a selected content item independent of the instructions received from the content publishing system 112.

The content publishing system 112 adaptively selects one or more representations of a digital content item for presentation to a user based on information or signals that indicate the user's reading ability. In the example shown by FIG. 1, the content publishing system 112 includes a user profile store 114, a content store 116, an interaction store 118, a user analysis module 120, and a scoring module 122. In other implementations, the content publishing system 112 may include additional, fewer, or different components for various applications. Conventional components, such as web servers and network interfaces are not shown as to not obscure the details of the system architecture.

Each user of the content publishing system 112 is associated with a user profile stored in the user profile store 114. A user profile includes declarative information about the user that was explicitly provided by the user and may also include profile information inferred by the content publishing system 112 or provided by an administrative user as previously described. In one embodiment, a user profile includes multiple data fields, each describing one or more attributes of the corresponding user of the content publishing system 112. Examples of information stored in a user profile include biographic, demographic, and other types of descriptive information, such as gender, content preferences, location, or other suitable information.

The interaction store 116 stores user interaction information describing interactions by a corresponding user with content items presented by the content publishing system 112. In one example, interaction information includes one or more of recordings of a user reading a text aloud, a list of words for which the viewing user requested vocabulary support, device level engagement data including notes taken by the viewing user and a count of the number of times a viewing user annotated (e.g., took notes), re-read their own annotations or annotations from peers or teachers, and the number of times a viewing user choose to adapt the text based on their own visual preferences. Interaction information also includes the sequencing of a viewing user's interactions during a reading session (i.e., the order in which any user interactions occur), answers that a viewing user provides to user assessment information, a record of any and all instances of a viewing user manually selecting an alternative version of a section of a selected content item. Interaction information further includes the pace at which a viewing user progresses through a selected content item, any information generated during playing a game or activity (i.e., assessment information) that is related to or embedded within a version of core text. Interaction information further includes, a record of links to third party sites that a user clicked on during a reading session, a record of any third party multimedia that was activated from links within the selected content item (e.g., a digital book), a record of interactions with other programs and applications on the users device, and a record of the time in which the content item was in idle mode as a result of cessation in user activity. In another implementation, user interaction data describing interactions with content items external to the content publishing system 112 may be retrieved from a third party processing system 108 and stored in the interaction store 116. In one example, a third party processing system 108 includes a separate website that receives interaction information (e.g., audible data) from the content publishing system 112 or an external source for processing and interpretation. For example, the third party processing system 108 receives an audio file, translates it to text, and sends the text back to the application on the client device 102 or sends the translated text to the content publishing system 112 for further processing. The audio file, the text generated from the audio file, and any associated metadata may be interpreted by the content publishing system 112 and used to calculate or update a user's reading score. In another example, the third party processing system 108 is a database with expected reading ability of for users of a specific age. In this example, the content publishing system 112 compares data collected and calculated within the content publishing system 112 with a wider set of data from a third party source. In a further example, the third party processing system 108 is a website used to grade user assessment information gathered by the content publishing system 112. In turn, the content publishing system 112 sends assessment results to the third party processing system 108, so that the third party processing system 108 may determine if the responses where correct or incorrect.

The content store 118 stores objects that each represent various types of content. For example, the content store 118 stores content items received from one or more sources 106. Examples of content items stored by the content store 118 include a digital book, a video, an article, or any other type of content. For each content item stored in the content store 118, the content publishing system 112 maps a user score or other measure associated with a determining a user's reading ability. The content store 118 also includes sets rules defining the conditions that determine which version of a text, primary text of secondary text (alternative versions of core text), is present to a specific user, based on the users reading score or other unique factors as previously described. The content store 118 also includes an expected user score for content items provided by a source 106. The user analysis module 120 retrieves user profile information from the user profile store 114, user interaction information from the interaction store 116, and analyzes the retrieved user interaction information in view of expected interaction information for a particular viewing user or group of users of the content publishing system 112. The scoring module 122 uses the analysis information received from the user analysis module 120 and rules and expected user scores stored in the content store 118 to calculate a present user score that represents the present reading ability of a viewing user.

### Selecting a Content Version Based on User Interaction Information

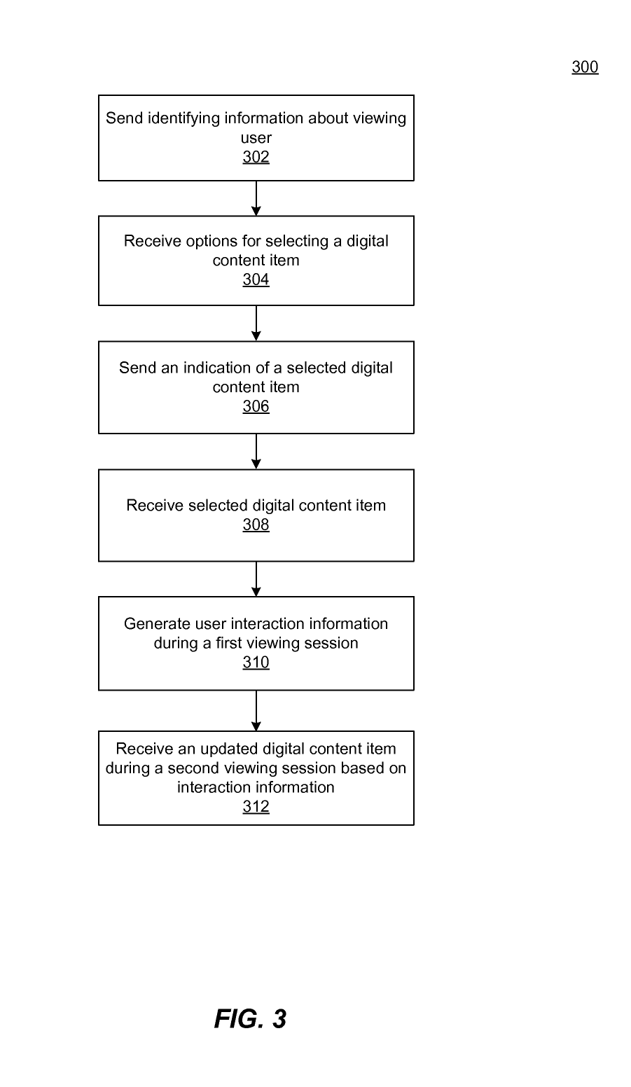

FIG. 2 is a flowchart of a process 200 for selecting a representation of a digital content item based on user interaction information. In one embodiment, the process 200 is performed by the content publishing system 112, which may perform the steps illustrated by FIG. 2 in different orders. Alternatively, the process 200 is performed by a content selection application executing on a client device 102 or by a combination of the content publishing system 112 and a content selection application executing on a client device 102. In some embodiments, different or additional steps than those shown in FIG. 3 may be performed.

The content publishing system 112 receives 202 identifying information describing one or more attributes of a viewing user from a viewing user via a client device 102 and the network 110. Example attributes of a viewing user include age, grade level, language fluency, or other user information that may be used by the content publishing system 112 to determine an expected user score. Alternatively or additionally, the content publishing system 112 receives 202 identifying information describing a user's reading ability from a third party, such as an educational institution, examination administration service, or an application accessible by the client device 102.

The content publishing system 112 determines 204 an expected user score of the viewing user based at least in part on the identifying information. In one embodiment, the content publishing system 112 determines an expected user score by computing scores based on attributes of the identifying information, historical interaction information associate with the user, global information describing identifying information about a group of user (e.g., a group comprising all fifth graders in public schools located in Santa Clara County, California), global information describing interaction information of a set of users of the content publishing system 112. Alternatively, the content publishing system 112 determines and expected user score based on information received from a source 106, such as a publisher, as previously described.

During a session (i.e., a viewing session) when the client device 102 is connected with the content publishing system 112, the content publishing system 112 receives 206 from the viewing user, a selection of a digital content item accessible from the content publishing system 112. In one example, the content publishing system 112 provides a user interface by which a requesting user interfaces with the content publishing system 112, using a client device 102, to select from among the various digital content items for download. As previously described, the digital content item is a file organized as multiple sections, where each section includes one or more versions information pertaining to the respective section.

The content publishing system 112 receives user interaction information describing one or more interactions by the viewing user with the selected digital content item. For example, the content publishing system 112 may retrieve user interaction information while connected to a client device 102 during a viewing session. Alternatively or additionally, the content publishing system 112 retrieves the user interaction information from a third party external to the content publishing system 112 or from an application residing on the client device.

The content publishing system 112 interprets the retrieved user interaction information and metadata, and uses the results of the interpretation to calculate 210 a present user score. For example, using the retrieved user interaction information and metadata the content publishing system 112 may determine one or more of the following: the viewing user's ability to read a text aloud with proper pacing, pronunciation and tone; the types of words for which a viewing user seeks vocabulary support; engagement level (i.e., is the viewing user demonstrating that they are activity engaging with the text by taking notes, re-reading their own notes, reading notes from a teacher or peers, and actively choosing to adapt the text based on their own visual preferences); how the viewing user responds to an adaption of their reading experience based on their reading score; a viewing user's ability to demonstrate to answer assessment information (e.g., a quiz or test correction after the content publishing system 112 has provided the viewing user support); a viewing user's determination to select an alternative version of a text, if available; the pace at which a viewing user progresses through a content item; the viewing user's level of reading skill across genres; a viewing user's ability to answer questions about the text; and a viewing user's ability to play or complete games or activities that require understanding of the text.

To calculate 210 a present user score the content publishing system 112 applies, using a processing device, one or more rules to one or more attributes of the interaction information. As previously described, the rules may be retrieved from the source (e.g., publisher), specified by administrative user, or otherwise specified. The content publishing system 112 uses the retrieved user interaction data and any supplemental data and applies an algorithm to that data, which compares data generated by the user to expectations for that user, based at least in part on the users' identifying information. In one example, the content publishing system 112 computes score, based on the following rules: if a viewing user can read aloud a portion of core text at their grade level correctly, increase present user score, otherwise if the viewing user cannot read the portion correctly decrease the score; if a viewing user request help on a vocabulary word that is below his grade level, decrease present user score, and if the viewing user requests help on vocabulary that is above his grade level, increase present user score; increase present user score when a viewing user annotates a content item; increase a present score of a viewing user if they read notes from another user; increase a present score of a viewing user if they read notes from a teacher; increase a present score of a viewing user if the viewing user revisits their own notes from a passage; increase a present user score of a viewing user if after downward adaptation in text difficulty, the viewing users reads at a faster pace, shows greater engagement, or answers a higher number of questions correctly; if a viewing user answers a question incorrectly for a second time, after having answered it incorrectly and then receiving support, decrease a present user score of the viewing user; if a viewing user selects text that are above their recorded grade level, increase a present user score of the viewing user; if a viewing user selects a text that is below their grade level, decrease a present user score of the viewing user; if a viewing user reads a book at a pace that is below expectation for their grade level, decrease present user score of the viewing user, but if they read a book at a pace that exceeds expectations for their grade level, increase the present score of a viewing user. The computed score may be weighted, for example, the score associated with whether a viewing user can read aloud a portion of core text at their grade level correctly may be weight highest of all computed scores.

The content publishing system 112 selects 212 for display to the viewing user based on the calculated user score, one or more updated or alternative version of section included in the previously selected content item. For example, the content publishing system 112 sends instructions to the user device 102 associated with the viewing user that causes code residing within the selected content item file to select the appropriate version of one or more sections of the selected content item, based on that viewing user's calculated present reading score. In one example, the instructions operate to substitute a version of core text, or direct an application residing on the client device 102 to reveal other forms of support that are specific to the viewing user's literacy and fluency. Furthermore, if a viewing user's answers an assessment question incorrectly, the instructions may also cause an application residing on the client device 102 to direct the viewing user to the area of the text that contains the correct answer to that specific question. The instructions may also cause an application residing on the client device 102 to reveal guidance on how to respond to specific types of questions. Instructions may also cause an application residing on the client device 102 to reveal other text, or other types of audio visual media, or links to other text and multimedia, that is intended to help the viewing user comprehend the text which they are reading.

FIG. 3 is a flowchart of another process for selecting a representation of a digital content item. In one embodiment, the process 300 is performed by the client device 102, which may perform the steps illustrated by FIG. 2 in different orders. Alternatively, the process 300 is performed by a combination of the content publishing system 112 and a content selection application executing on a client device 102. In some embodiments, different or additional steps than those shown in FIG. 3 may be performed.

The client device 102 sends 302 identifying information describing one or more attributes of a viewing user from a viewing user via the network 110. The identifying information is similar to that described with respect to step 202 of FIG. 2. The client device 102 receives 304 from the content publishing system 112 one or more options for selecting a digital content item. In one example, the client device 102 may include a user interface that allows a viewing user to select a digital content item included in the content publishing system 112 during a viewing session. Response to a selection made by the viewing user, the client device 102 sends 306 an indication of that a particular content items was selected using the device associated with the viewing user. Responsive to the selection, the client device 102 receives 308 the selected digital content item. As previously described, the received selected content item includes one or more alternative versions of core text, user assessment information, and user assist information. The received selected content item also includes instructions operable to cause an application residing on the client device to select from among alternative versions of core text, user assessment information, user assist information based on interaction data provided to the content publishing system by the client device 102.

During a viewing session, which may occur when the client device 102 is not in communication with the content publishing system 112, the client device 102 generates 310 interaction information describing interactions of the viewing user with a selected content item. This may occur in an online or an offline mode, where the client device 102 is not connected to the content publishing system 112. The generated interaction information may be stored locally on the client device 102, or uploaded to the content publishing system 112 during a subsequent viewing session. For example, during a subsequent viewing session, the client device 102 may receive 312 instructions that when executed by an application residing on the client device 102 to select an updated or alternative version of core text, user assessment information, or user assist information based on the interaction information provided to the content publishing system 112. The received selected content item also includes instructions operable to cause an application residing on the client device 102 operating in an offline mode to select from among alternative versions of core text, user assessment information, and user assist information based on interaction data logged by the client device 102. The instructions may also cause an application residing on the client device 102 to reveal guidance on how to respond to specific types of questions. Instructions may also cause an application residing on the client device 102 to reveal other text, or other types of audio visual media, or links to other text and multimedia, that is intended to help the viewing user comprehend the text which they are reading.

### Summary

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory, tangible computer-readable medium containing computer program code, which can be executed by a computer processor for performing any or all of the steps, operations, or processes described.

Embodiments of the disclosure may also relate to an apparatus for performing the operations herein. This apparatus may be specially constructed to adaptively select, during a viewing session, a representation of a digital content item based on a user's literacy and fluency level, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving identifying information describing one or more attributes of a viewing user;
determining an expected user score of the viewing user based at least in part on the identifying information;
receiving from the viewing user, a selection of a digital content item accessible from the content publishing system, the digital content item comprising a plurality of content versions, a plurality of levels of user assessment information, and a plurality of levels of user assist information;
receiving user interaction information describing one or more interactions by the viewing user with the selected digital content item;
calculating a present user score by applying, using a processing device, one or more rules to one or more attributes of the interaction information; and
selecting, for display to the viewing user based on the calculated user score, one or more updated content versions of the plurality of content versions, one or more updated levels of user assessment information, and one or updated more levels of user assist information of the selected digital content item based at least in part on the calculated score.

2. The method of claim 1, further comprising updating the expected user score of the viewing user based on the calculated score.

3. The method of claim 1, wherein the received user interaction information comprises an audible recording of the viewing user interacting with the selected digital content item.

4. The method of claim 1, wherein the received user interaction information comprises an indication of a level of engagement of the viewing user with the selected digital content item.

5. The method of claim 1, wherein the received user interaction information comprises a sequence of interactions of the viewing user with the digital content item.

6. The method of claim 1, wherein the received user interaction information comprises responses of the viewing user to one or more queries included in the user assessment information presented to the viewing user.

7. The method of claim 1, wherein a content version specifies a modification in vocabulary of content compared with other content versions of the same digital content item.

8. The method of claim 1, wherein a content version specifies one or a combination of modifications in sentence structure of content compared with other content versions of the same digital content item.

9. The method of claim 1, wherein the user assist information comprises one or a combination of vocabulary support, reformatted text, visual modifications applied to portions of text associated with an attribute of the content version.

10. A method comprising:
sending, to a content publishing system, identifying information describing one or more attributes of a viewing user;
receiving from the content publishing system one or more options for selecting a digital content item;
sending to the content publishing system an indication of a selected digital content item from the one or more options;
receiving the selected digital content item, the selected digital content item comprising a content version, a level of user assessment information, and a level of user assist information;
generating, during a first viewing session, user interaction information describing one or more interactions by the viewing user with the selected digital content item; and
receiving, during a second viewing session, instructions for displaying on a viewing device associated with the viewing user, a modified content version of the selected digital content item based on the generated user interaction information.

11. The method of claim 10, further comprising, receiving, during the second viewing session, for display on the viewing device associated with the viewing user, a modified level user assessment information based on the generated user interaction information.

12. The method of claim 11, wherein the modified level of user assessment information comprises a modification in content of a query presented to the viewing user.

13. The method of claim 11, wherein the modified level of user assessment information comprises a modification in a type of query presented to the viewing user.

14. The method of claim 10, wherein the first viewing session and the second viewing session are the same viewing session.

15. The method of claim 10, further comprising, receiving for display on the viewing device associated with the viewing user, a modified level of user assist information based on the generated user interaction information.

16. The method of claim 10, wherein the generated user interaction information comprises audible information of the viewing user interacting with the selected digital content item.

17. The method of claim 10, wherein the generated user interaction information comprises responses of the viewing user to one or more queries included in the user assessment information presented to the viewing user.

18. The method of claim 10, wherein the modified content version comprises a modification in vocabulary of content included in the selected digital content item compared to the previously received content version of the selected digital content item.

19. The method of claim 10, wherein the user assist information comprises one or a combination of vocabulary support, reformatted text, visual modifications applied to portions of text associated with an attribute of the content version.

20. A computer-readable medium storing executable computer program instructions for modifying the presentation of a digital content item, the computer program instructions comprising instructions for:
receiving identifying information describing one or more attributes of a viewing user;
determining an expected user score of the viewing user based at least in part on the identifying information;
receiving from the viewing user, a selection of a digital content item accessible from the content publishing system, the digital content item comprising a plurality of content versions, a plurality of levels of user assessment information, and a plurality of levels of user assist information;
receiving user interaction information describing one or more interactions by the viewing user with the selected digital content item;
calculating a present user score by applying, using a processing device, one or more rules to one or more attributes of the interaction information; and
selecting, for display to the viewing user based on the calculated user score, one or more content versions of the plurality of content versions, one or more levels of user assessment information, and one or more levels of user assist information of the selected digital content item based on the calculated score.
